(19) United States
(12) Patent Application Publication
(10) Pub. No.: US 2012/0121912 A1
(43) Pub. Date: May 17, 2012

(54) LAMINATED STRUCTURE

(75) Inventors: Karikath Sukumar Varma, Merseyside (GB); Benjamin Michael Stiefvater-Thomas, Lancashire (GB)

(73) Assignee: PILKINGTON GROUP LIMITED, St. Helens (GB)

(21) Appl. No.: 13/261,080

(22) PCT Filed: Jun. 14, 2010
(86) PCT No.: PCT/GB2010/050991

§ 371 Date: Jan. 17, 2012

(30) Foreign Application Priority Data
Jun. 16, 2009 (GB) 0910295.5

(51) Int. Cl. B32B 27/38; B05D 5/00; C09D 7/12; B32B 9/04

(52) U.S. Cl. 428/413; 428/446; 428/447; 428/451; 427/256; 522/42

(57) ABSTRACT

A laminated structure comprising at least one glazing pane, at least one interlayer, and a seal covering at least one edge of the interlayer, wherein the seal comprises a nano-particulate silicon oxide.

This invention relates to laminated structures having seals covering the edges of the laminated structures, methods for sealing the edges of laminated structures and sealing dispersions useful for such methods. In particular, this invention relates to laminated structures comprising photovoltaic modules containing one or more photovoltaic cells and having seals covering the edges of such structures.

Laminated structures comprising one or more glazing panes and an interlayer (usually a polymer interlayer) are often produced with the polymer edge or edges exposed. Over time this can lead to degradation of the polymer, particularly at the interface with the glazing pane, due to environmental weathering including water ingress. Such degradation may be visible by the formation of haze, or by delamination at the edges, visible through the glazing pane. By sealing these exposed edges (particularly against ingress of moisture) the appearance and life of the structure may be improved.

One important type of laminated structure is the photovoltaic module. Typically, a photovoltaic module comprises a glazing sheet, often of glass, a backing plate, functional components (which may include semiconductor wafers and/or thin films coated on one of the glazing sheets) and an interlayer joining the glazing sheet, the backing plate and encapsulating the functional components. A photovoltaic module may be damaged if water passes into the cell. In addition, the semiconductor components of photovoltaic modules may include toxic elements such as cadmium, arsenic, tellurium or selenium. It is also important, therefore, to ensure a proper seal at the edge of the photovoltaic modules to reduce or prevent migration of such elements out of the edges of the module and into the environment. Preferably, edge seals of photovoltaic modules and other laminated structures are chemically and scratch resistant. They are also preferably electrically insulating.

U.S. Pat. No. B2-6,673,997 discloses a solar module containing thin film solar cells and a border seal at the external edge of the plates. The border seal includes an elastomeric spacer that contains a moisture absorbing medium and is coated with an external peripheral adhesive bead.

There is, however, a need for improved edge seals on laminated structures. It is the aim of the present invention to provide such seals and to overcome the deficiencies of the prior art.

The present invention accordingly provides, in a first aspect, a laminated structure comprising at least one glazing pane, at least one interlayer, and a seal covering at least one edge of the interlayer, wherein the seal comprises a nano-particulate silicon oxide.

In a second aspect, the present invention provides a method for sealing the edge of a laminated structure comprising at least one glazing pane, at least one interlayer, and a seal covering at least one edge of the interlayer, the method comprising applying a sealant or a sealant dispersion comprising a nano-particulate silicon oxide to at least one edge of the interlayer.

In a third aspect, the present invention provides a polymerisable sealant dispersion comprising a nano-particulate silicon oxide dispersed in a polymerisable liquid medium. The polymerisable sealant dispersion of the third aspect of the invention has many uses including in a method according to the second aspect of the invention and as discussed below.

The interlayer is preferably a polymer interlayer. The polymer interlayer may be a polymer film (e.g. of PVB, EVA, PVC, PETP, PVA, Polyurethane or an ionomer) having one or more layers. The interlayer may be a cast interlayer (e.g. polybutylacrylate).

The interlayer is not an intumescent interlayer (i.e. the interlayer is non-intumescent).

The laminated structure may be generally any structure containing a glazing pane and an interlayer, preferably a polymer interlayer. The laminated structure may comprise (or may be) a photovoltaic module. The photovoltaic (PV) module may comprise one or more photovoltaic cells. Generally, the PV cells may be any known PV cell including wafer and/or thin film cells.

In the case of a PV module, it is preferred if the interlayer is a polymer interlayer. The polymer of the interlayer is preferably selected from PVB, EVA and an ionomer (e.g. as sold by Du Pont as the PV5300 series).

The or each PV cell may contain components comprising Cu, Ag, Au, Al, Ga, In, S, Se, Te, Cd, As, Mo or Ru.

The seal of the present invention is advantageous because it both significantly reduces ingress of water (and other atmospheric components) and also reduces or prevents migration of elements (especially toxic elements in e.g. a photovoltaic module) into the environment. PV panels operate at voltages of up to 3000V and are situated outdoors where they are frequently exposed to rainwater. It is therefore advantageous that the seals of the invention are good electrical insulators. An additional benefit of the seal of the present invention is that it significantly enhances scratch resistance. Usually the seal of the present invention is transparent or translucent providing a further advantage.

The glazing pane or glazing panes may be transparent or translucent plastics panes. Preferably, however, at least one of the glazing panes is a glass pane.

The sealant preferably comprises nano-particulate silicon oxide (preferably silica) particles dispersed in a liquid medium to form a sealant dispersion. The liquid medium may comprise additives to control and stabilise the storage, handling, application and subsequent cure of the formulation to form a film.

The nano-particulate silica is preferably an organically modified silica. Organically modified silicas are known as Ormosils and are generally silica nano-particles which have been modified by treatment with an organic compound in a manner which converts the silanol groups (on the surface of the silica particles) to Si—O—C groups. The modified silica particles are more soluble and/or more dispersible in organic media. They show less tendency to aggregate than do unmodified silica particles. Without wishing to be bound by any theory the applicants believe that sealants which comprise nano-particulate silica and in particular those which comprise organically modified silicas provide superior resistance to diffusion based migration of chemical species including gases.

Silica particles may be treated with a variety of organic compounds containing reactive functionalities such as epoxides, silicones, acrylates, urethanes, isocyanates, or urethane acrylates in order to produce a polymerisable Ormosil. Examples of organic compounds which can be used to produce a polymerisable Ormosil include diglycidylether tetrabromo bisphenol A, 2-hydroxyethyl methacrylate, dipropyleneglycol diacrylate, tripropyleneglycol diacrylate, cyclic trimethylolpropane formal acrylate and isobornyl acrylate. The polymerisable Ormosil is preferably dispersed or dissolved in an organic medium. Ormosils are available as articles of commerce and any of those commercially available materials are potentially useful in the present invention including those Ormosils based on non-polymerisable organic functionalities such as glycerol, ethylene glycol and propylene glycol.

The silica particles used in this invention will preferably have an average particle size which is within the range of 1 to 200 nm. Particles which have a size greater than 80 nm may form a less transparent film which in the extreme may be opaque. For this reason when a clear seal is desired the silica particles will preferably have an average particle size which is less than 70 nm and may typically have an average particle size of approximately 50 nm.

The liquid medium is preferably capable of forming a film which is non porous and acts as a barrier to the passage of both gases and liquids.

The film comprising the nano-particulate silica should extend over the exposed edge of the interlayer and at least a part of the exposed edges of the glazing pane(s) and thereby constitute a continuous seal extending around the perimeter of the structure.

The sealant may take the form of an adhesive tape having nano-particulate silica particles dispersed through the adhesive layer. The tape may be formed from a variety of materials including acrylics. The improved performance of the seal comprising the nano-particles means that there may be no necessity to use the known metallic tapes (which are often used to reduce water ingress) in order to achieve a satisfactory seal. The nanoparticulate silica may be applied to metallic tapes but this is less preferred as it adds extra cost to what is an acceptable product.

A film may be formed by actively drying the sealant dispersion or by allowing excess liquid to evaporate. But, in a preferred embodiment, the nano-particulate silica is dispersed in a polymerisable liquid medium which comprises at least one monomer or oligomer which may be cured to form a polymeric film. The dispersion may be applied to the edge of the structure and cured immediately thereafter.

Preferably the curing reaction is one which can be initiated by the application of e.g. UV radiation, or E beam radiation which can be directed onto the dispersion immediately after it has been applied to the edges of the structure. Alternatively, curing may be carried out by heating at an elevated temperature (e.g. 50 to 120° C.).

The preferred media for use in the present invention include epoxies, silicones, urethanes, acrylates and methacrylates and their co-polymers. Film forming media which comprise a blend of more than one component are also useful in the present invention.

The sealant dispersion and/or the seal preferably contains from 1% to 75% by weight of silica, more preferably from 10 to 60% by weight of silica and most preferably from 10 to 50% by weight of silica. The nano-particulate silica (e.g. the Ormosil) and the medium in which it is dispersed will be selected so as to enable a stable dispersion containing the desired percentage solids content to be produced.

The viscosity of the sealant dispersion may be adjusted by selection of the film forming media or by adjusting the composition of the film forming medium. The preferred viscosity of the sealant dispersion varies according to a number of parameters including the method of application, the roughness of the surfaces to which the solution or dispersion is applied and the thickness of the seal which is to be produced.

The sealant dispersion is generally applied directly or indirectly to the exposed edges of the polymer interlayer in a manner such that the free surfaces of the interlayer and at least the adjacent edge(s) of the glazing pane(s) are completely covered, thereby forming the seal.

Where the structure comprises more than one interlayer or other components as well as the interlayer (e.g. thin film coatings or wafers) the seal will preferably cover the whole of the exposed edges of the pane(s) and the interlayer(s).

An adhesion promoter (such as a silane primer, especially useful wherein the glazing pane is glass) may be applied to the surfaces of the edge of the laminated structure before the film is applied in order to provide a priming layer and to improve the adhesion between the cured film and the laminated structure. Alternatively, an adhesion promoter may be added to the sealant or sealant dispersion to improve the adhesion characteristics.

The edge of the laminated structure may be planar, rounded or bevelled. The edge of the interlayer may lie below the edge of the glazing pane(s) and/or any backing plate and thereby define a channel. The surface of the glazing pane(s) or backing plates and especially the surfaces of the edges of a glass glazing pane may comprise microscopic cracks and other imperfections. A further great advantage of the present invention is that the sealant or sealant dispersion will fill these cracks, thus reducing the likelihood of rainwater collecting at the edge of a laminate. The film and hence seal produced should be coherent and continuous and should cover the surface of the interlayer and at least a part of the edge of each layer of the laminated structure.

The thickness of the film (and hence the seal) which is produced is proportional to the amount of sealant which is applied. Thicker films may be produced by repeated applications of the sealant or by rheologically modifying the sealant using conventional thickening agents known in the art and compatible with the organic medium selected. Generally the thickness of the sealant above the exposed surface of the interlayer will be less than 10 mm, preferably less than 5 mm, more preferably less than 3 mm and more usually less than 2 mm.

The application of the sealant may be continued until a film of the desired thickness has been formed on the edge of laminated structure. The thickness of the film is the thickness of the coherent film which extends above the surface of the interlayer. The desired thickness may vary through a wide range typically from 20 μm to 2 mm or even as thick as 3 mm, 5 mm or 10 mm.

The sealant dispersion should generally not be applied in excessive quantities because this can lead to the dispersion running down the major surfaces of the structure which is not aesthetically acceptable in most applications and (in the case of photovoltaic cells may reduce efficiency).

In the preferred embodiments the curing is carried out under conditions which control oxygen inhibition of the polymerisation reaction. Processes in which the curing is carried out in the presence of an oxygen scavenger are preferred. Processes in which the curing is initiated using UV radiation and carried out under an inert atmosphere are also useful but may be less practical in a production environment.

Laminated structures having seals as described above are, in addition to their other advantages, generally stable to weathering as shown by accelerated weathering and other testing. Usually, the appearance of the seal is not significantly changed after exposure to elevated humidity and temperature, such as 99% relative humidity at 50° C. for a period of 350 hours, or exposure to the atmosphere at a temperature of 70° C. for a period of 1000 hours.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

Embodiments of the invention will now be described with reference to the following drawings in which:

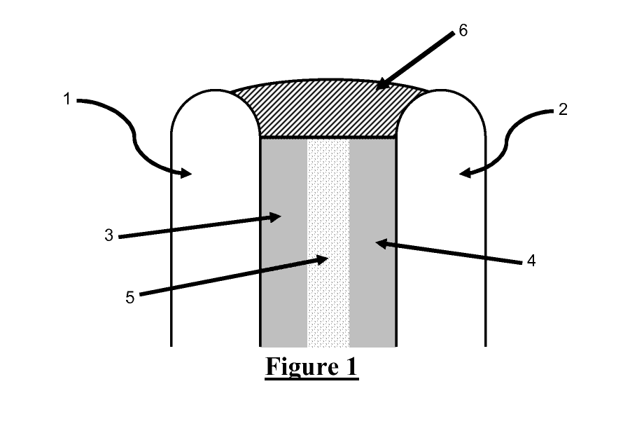

FIG. 1 illustrates a crystalline silicon photovoltaic module having an edge seal;

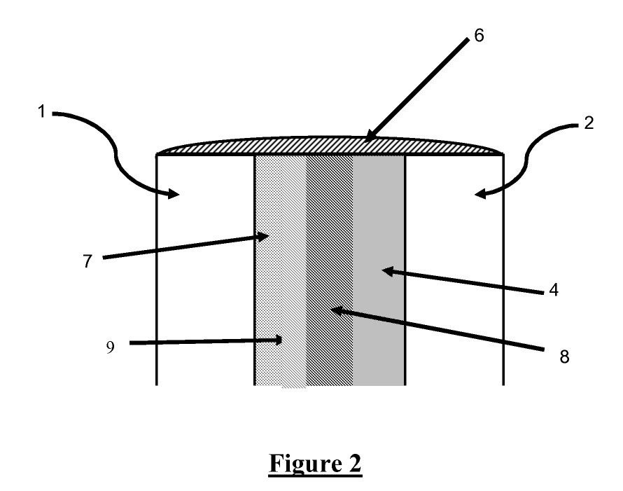

FIG. 2 illustrates a thin layer photovoltaic module having an edge seal; and

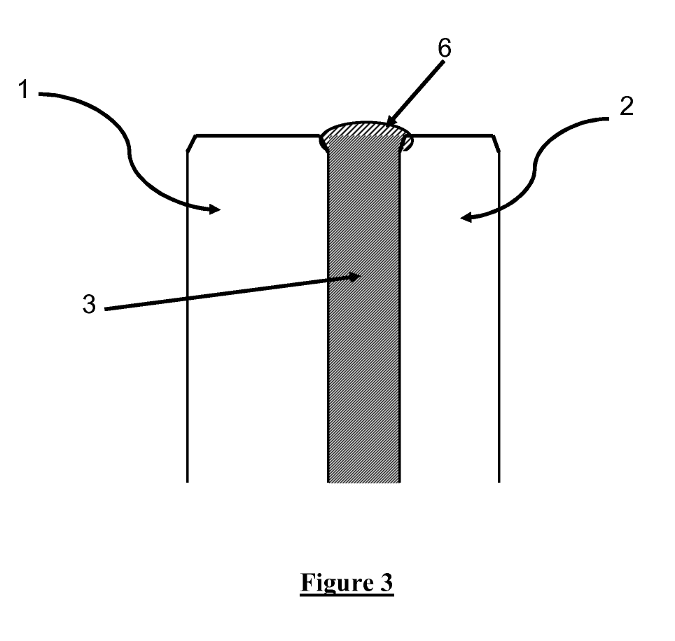

FIG. 3 illustrates a laminated glazing having an edge seal.

In FIG. 1, a crystalline silicon photoactive wafer 5 is encapsulated between two interlayer films 3 and 4 of ethylene vinyl acetate. The silicon wafer and interlayer films are laminated between a glass superstrate 1 and a glass back plate 2. The edges (only one edge is shown for clarity) of the structure are sealed using a seal 6 comprising nano-particulate silica. The seal 6 fills the recess formed by the rounded glass edges and partially extends over their surface.

In FIG. 2 a coated glass superstrate pane 1 has, on its surface facing inside the laminate, a transparent conductive oxide (TCO) coating (not shown) of, for example fluorine doped tin oxide. Deposited on the TCO coating is a cadmium sulfide layer 7. In contact with the cadmium sulfide layer 7 is a cadmium telluride layer 9. In contact with the cadmium telluride layer is a metal layer 8. The coated glass pane 1 with its coating layers is encapsulated to a glass back plate 2 with an interlayer film 4 of ethylene vinyl acetate. The edges (only one edge is shown for clarity) of the structure are sealed using a seal 6 comprising nano-particulate silica. The seal 6 extends over the surface of the interlayer as well as the entire surface of the glass edges.

In FIG. 3, a poly(vinyl butyral) (PVB) interlayer sheet 3 is laminated between a toughened glass pane 1 and a heat strengthened glass pane 2. The edges (only one edge is shown for clarity) of the structure are sealed using a seal 6 comprising nano-particulate silica. The seal 6 forms a narrow bead over the PVB interlayer 3 and extends slightly on to the exposed glass edges.

The seal 6 in each of the laminated structures may be formed by supporting the laminate in a vertical or substantially vertical position and applying a sealant or sealant dispersion according to the invention to the top edge of the glazing. The thickness of the seal produced is proportional to the amount of sealant/sealant dispersion which is applied and the size and shape is governed by the surface tension of the sealant/sealant dispersion. The quantity of sealant/sealant dispersion which is applied will normally be controlled so as to avoid excess overflowing the top edges of the glazing and contaminating the major surfaces of panes 1 or 2.

The quality of the seal which is produced may be tested by accelerated ageing and weathering tests on the sample (e.g. for PV modules under IEC 61646 (thin film PV modules) or BS EN 61215-2005 (crystalline silicon PV modules)). Storage at elevated temperatures and storage at near 100% humidity tends to lead to degradation of the sample unless the seal is of sufficient quality at the edge. Seals as described herein improve performance significantly.

The appearance of the material making up the seal of this invention has been tested by exposure to the atmosphere at elevated temperatures. The appearance of the material was unchanged after 1000 hours at 70° C.

The invention is further illustrated by the following Examples:

Sealant dispersions having one of the compositions described in Examples 1 to 5 below may be applied to the upward facing edge of a laminated structure after cleaning of the edge with isopropyl alcohol or another suitable agent. The laminated structure may be supported in a vertical position in such a way that the edge region is freely accessible. By combining the use of a suitable dispensing device and a doctor blade, an even coating of the liquid sealant may be applied on the upward facing edge of the structure. The sealant dispersion may be cured using UV radiation (190-380 nm at room temperature for 20 seconds) and will produce a highly transparent and colourless layer on the edge of the laminated structure.

The sealant used according to the invention can, in particular, protect the interior of laminated structures from ingress of water or e.g. oxygen. In particular, the seal of the present invention protects the components of PV modules from water or oxygen ingress and reduces or prevents migration of components (including, for example, toxic components) from the PV module to the environment.

### Example 1

| Constituent | Proportion [%] |
|---|---|
| HIGHLINK ® NanOG 107-53 ⁽¹⁾ | 48.5 |
| PPGMA ⁽²⁾ | 40 |
| Genomer 4269/M22 ® ⁽³⁾ | 10 |
| Darocur 1173 ® ⁽⁴⁾ | 1.5 |

Concerning the constituents used
⁽¹⁾ Dipropyleneglycol Diacrylate containing 50% SiO₂ (Clariant)
⁽²⁾ Polypropyleneglycol methacrylate Mn~375 (Sigma-Aldrich)
⁽³⁾ Aliphatic Urethane Acrylate (Rahn)
⁽⁴⁾ 2-Hydroxy-2-methyl-1-phenyl-propan-1-one (Ciba Specialty Chemicals)

### Example 2

| Constituent | Proportion [%] |
|---|---|
| HIGHLINK ® NanOG 108-32 ⁽¹⁾ | 25 |
| PPGMA ⁽²⁾ | 73.5 |
| Darocur 1173 ® ⁽³⁾ | 1.5 |

Concerning the constituents used
⁽¹⁾ Tripropyleneglycol Diacrylate containing 30% SiO₂ (Clariant)
⁽²⁾ Polypropyleneglycol methacrylate Mn~375 (Sigma-Aldrich)
⁽³⁾ 2-Hydroxy-2-methyl-1-phenyl-propan-1-one (Ciba Specialty Chemicals)

### Example 3

| Constituent | Proportion [%] |
|---|---|
| HIGHLINK ® NanOG 103-53 ⁽¹⁾ | 48.5 |
| PPGMA ⁽²⁾ | 50 |
| Darocur 1173 ® ⁽³⁾ | 1.5 |

Concerning the constituents used
⁽¹⁾ 1,6-Hexanediol Diacrylate containing 50% SiO₂ (Clariant)
⁽²⁾ Polypropyleneglycol methacrylate Mn~375 (Sigma-Aldrich)
⁽³⁾ 2-Hydroxy-2-methyl-1-phenyl-propan-1-one (Ciba Specialty Chemicals)

### Example 4

| Constituent | Proportion [%] |
|---|---|
| HIGHLINK ® NanOG 130M-31 ⁽¹⁾ | 55 |
| Miramer M600⁽²⁾ | 15 |
| Genomer 4269/M22 ® ⁽³⁾ | 25 |
| Genocure MBF ® ⁽⁴⁾ | 5 |

Concerning the constituents used
⁽¹⁾ Isobornyl acrylate containing 30% SiO₂ (Clariant)
⁽²⁾Dipentaerythritol Hexaacrylate (Rahn)
⁽³⁾ Aliphatic Urethane Acrylate (Rahn)
⁽⁴⁾ Methylbenzoylformate (Rahn)

### Example 5

| Constituent | Proportion [%] |
|---|---|
| HIGHLINK ® NanOG 130M-31 ⁽¹⁾ | 52.2 |
| Miramer M600⁽²⁾ | 14.24 |
| Genomer 4269/M22 ® ⁽³⁾ | 23.73 |
| Genocure MBF ® ⁽⁴⁾ | 4.75 |
| Mequinol⁽⁵⁾ | 0.95 |
| Pentaerythritol tetrakis (3-mercaptopropionate)⁽⁶⁾ | 5 |

Chemical description of constituents used
⁽⁵⁾ Isobornyl acrylate containing 30% SiO₂ (Clariant)
⁽⁶⁾ Dipentaerythritol Hexaacrylate (Rahn)
⁽⁷⁾ Aliphatic Urethane Acrylate (Rahn)
⁽⁸⁾ Methylbenzoylformate (Rahn)
⁽⁹⁾ 4-Methoxyphenol (Sigma-Aldrich)
⁽¹⁰⁾ Pentaerythritol tetrakis(3-mercaptopropionate) (Sigma-Aldrich)

1-16. (canceled)

17. A laminated structure comprising at least one glazing pane, at least one interlayer, and a seal covering at least one edge of the interlayer, wherein the seal comprises a nano-particulate silicon oxide.

18. The laminated structure as claimed in claim 17, wherein the interlayer comprises a polymer interlayer.

19. The laminated structure as claimed in claim 17, wherein the laminated structure comprises a photovoltaic module.

20. The laminated structure as claimed in claim 17, wherein the seal comprises an adhesive tape having nano-particulate silicon oxide dispersed in the adhesive layer.

21. The laminated structure as claimed in claim 17, wherein the seal is obtainable by applying a sealant dispersion to the edge of the interlayer, the sealant dispersion comprising a nano-particulate silicon oxide dispersed in a film forming medium.

22. The laminated structure as claimed in claim 21, wherein the film forming medium is a polymerisable liquid medium.

23. The laminated structure as claimed in claim 22, wherein the film forming medium comprises a polymerisation initiator.

24. The laminated structure as claimed in claim 22, wherein the film forming medium comprises a photo-polymerisable monomer or oligomer and a photoinitiator.

25. The laminated structure as claimed in claim 21, wherein the film forming medium is a medium selected from the group comprising epoxy resins, urethanes, silicones, acrylates, methacrylates and their co-polymers.

26. The laminated structure as claimed in claim 17, wherein the nano-particulate silicon oxide is an organically modified nano-particulate silicon oxide.

27. The laminated structure as claimed in claim 17, wherein the seal comprises from 1% to 75% by weight of silica.

28. The laminated structure as claimed in claim 17, wherein the appearance of the seal is not significantly changed after exposure to the atmosphere at a temperature of 70° C. for a period of 96 hours.

29. A method for sealing the edge of a laminated structure comprising at least one glazing pane, at least one interlayer, and a seal covering at least one edge of the interlayer, the method comprising applying a sealant comprising a nano-particulate silicon oxide to at least one edge of the interlayer.

30. The method as claimed in claim 29, wherein the sealant is applied to the edges of the interlayer and the sealant is polymerised by heat.

31. The method as claimed in claim 29, wherein the desired thickness of seal is obtained by repeated application of the sealant.

32. A polymerisable sealant dispersion comprising a nano-particulate silicon oxide dispersed in a polymerisable liquid medium.
